(19) United States
(12) Patent Application Publication
(10) Pub. No.: US 2009/0092903 A1
(43) Pub. Date: Apr. 9, 2009

(54) Low Cost Solid State Rechargeable Battery and Method of Manufacturing Same

(76) Inventors: Lonnie G. Johnson, Atlanta, GA (US); Steve Buckingham, Decatur, GA (US); Davorin Babic, Marietta, GA (US); David Johnson, Atlanta, GA (US); Manuel Johnson, Lilburn, GA (US)

Correspondence Address: BAKER, DONELSON, BEARMAN, CALDWELL & BERKOWITZ;Intellectual Property Department, Monarch Plaza, Suite 1600, 3414 Peachtree Rd., ATLANTA, GA, 30326, US

(21) Appl. No.: 12/198,421

(22) Filed: Aug. 26, 2008

Related U.S. Application Data
(60) Provisional application No. 60/968,638, filed on Aug. 29, 2007.

(51) Int. Cl. H01M 4/02; B29C 67/04

(52) U.S. Cl. 429/322; 429/209; 264/104

(57) ABSTRACT

A solid state Li battery and an all ceramic Li-ion battery are disclosed. The all ceramic battery has a solid state battery cathode comprised of a mixture of an active cathode material, an electronically conductive material, and a solid ionically conductive material. The cathode mixture is sintered. The battery also has a solid state battery anode comprised of a mixture of an active anode material, an electronically conductive material, and a solid ionically conductive material. The anode mixture is sintered. The battery also has a solid state separator positioned between said solid state battery cathode and said solid state battery anode. In the solid state Li battery the all ceramic anode is replaced with an evaporated thin film Li metal anode.

### REFERENCE TO RELATED APPLICATION

Applicant claims the benefit of U.S. Provisional Patent Application Ser. No. 60/968,638 filed Aug. 29, 2007.

### TECHNICAL FIELD

This invention relates generally to the construction of an all solid state battery and a method of manufacturing same.

### BACKGROUND OF THE INVENTION

The present invention relates to solid-state batteries having the following generally attractive properties: (1) long shelf life, (2) good power capability, (3) hermetically sealed, no gassing, (4) broad operating temperature range: −40 to 170° C. for pure lithium anodes, up to and beyond 300° C. with compound anodes, (5) high volumetric energy density, up to 1000 Wh/L. They are particularly suited for applications requiring long life at low-drain or open-circuit conditions.

An all solid state lithium battery was developed under the trade name Duracell in the 1970's and made commercially available in the 1980's, but are no longer produced. The cells used a lithium metal anode, a dispersed phase electrolyte of LiI and Al₂O₃ and a metal salt cathode. The Li/LiI(Al₂O₃)/metal salt construction was a true solid-state battery. These batteries were not rechargeable and required external metal packaging as the constituent materials were not stable in ambient air. These all solid-state primary cells demonstrated very high energy densities of up to 1000 Wh/L and excellent performance in terms of safety, stability and low self discharge. However, due to the pressed powder construction and the requirement for a thick electrolyte separation layer, the cell impedance was very high, severely limiting the discharge rate of the battery. This type of cell is also restricted in application because the electrochemical window is limited to less than 3 volts due to the iodide ions in the electrolyte which are oxidized above 3 volts. In addition, a stable rechargeable version of this cell was never developed.

In the early 1990's another all solid state battery was developed at the Oak Ridge National Laboratories, as shown in U.S. Pat. Nos. 5,512,147 and 5,561,004. These cells consist of thin films of cathode, electrolyte, and anode deposited on a ceramic substrate using vacuum deposition techniques including RF sputtering for the cathode and electrolyte, and vacuum evaporation of the Li metal anode. The total thickness of the cell components is typically less than 10 μm with the cathode being less than 4 μm, the solid electrolyte around 2 μm (just sufficient to provide electrical isolation of the cathode and anode) and the Li anode also around 2 μm. Since strong chemical bonding (both within each layer and between the layers of the cell) is provided by the physical vapor deposition technique, the transport properties are excellent. Although the solid electrolyte LiPON has a conductivity of only 2×10⁻⁶ Scm⁻¹ (50 times lower than that of the LiI(Al₂O₃) solid electrolyte used in the Duracell battery described above) the impedance of the thin 2 μm layer is very small allowing for very high rate capability. However, batteries based on this technology are very expensive to fabricate. They have very low capacity and require external packaging which result in very low specific energy and energy density.

These all solid-state thin film batteries address many of the problems associated with Li ion technology but also has limitations of its own. The vacuum deposition equipment required to fabricate the cells is very expensive and the deposition rates are slow leading to very high manufacturing costs. Also, in order to take advantage of the high energy density and power density afforded by use of the thin films, it is necessary to deposit the films on a substrate that is much smaller and lighter than the battery layers themselves, such that the battery layers make up a significant portion of the volume and weight of the battery compared to inert components such as the substrate and packaging. It is not practical to simply deposit thicker layers, as the cathode thickness is limited to less than 51 μm due to lateral cracking of the film caused by expansion and contraction of the layer during charge and discharge of the cell. Therefore the films must be deposited on very thin substrates (<10 μm) or multiple batteries must be built up on a single substrate, which leads to similar problems during charge and discharge.

Currently, Li-ion battery chemistry gives the highest performance and is becoming more widely used of all battery chemistries. The cells consist of thick (˜100 μm) porous composite cathodes cast on a thin (˜10 μm) Al foil current collector. The composite cathode contains LiCoO₂ as the active material due to its high capacity and good cycle life, and carbon black to provide electronic conductivity throughout the layer. A thin polymer separator is used to provide electrical isolation from the carbon anode which intercalates Li during the charge cycle. The cell is immersed in liquid electrolyte which provides very high conductivity for the transport of Li ions between the cathode and anode during charge and discharge. Because the thick composite cathode is porous the liquid electrolyte is absorbed into and fills the structure and thus provides excellent surface contact with the LiCoO₂ active material to allow fast transport of Li ions throughout the cell with minimal impedance. The liquid electrolyte itself consists of a Li salt (for example, LiPF₆) in a solvent blend including ethylene carbonate and other linear carbonates such as dimethyl carbonate. Despite improvements in energy density and cycle life there remains an underlying problem with batteries that contain liquid electrolytes. Liquid electrolytes are generally volatile and subject to pressure build up, explosion and fire under high charge rate, high discharge rate or internal short circuit conditions. Charging at high rate can cause dendritic lithium growth on the surface of the anode. The resulting dendrites can extend through the separator and cause a short circuit in the cell. The self discharge and efficiency of the cell is limited by side reactions and corrosion of the cathode due to the liquid electrolyte. The liquid electrolyte also creates a hazard if the cell over heats due to over voltage or short circuit conditions creating another potential fire or explosion hazard.

It thus is seen that a need remains for a battery with improved performance and safety over existing Li-ion technology, preferably one that removes the need for liquid electrolyte in the cell. Accordingly, it is to the provision of such that the present invention is primarily directed.

### SUMMARY OF THE INVENTION

In a preferred form of the invention, the solid state battery comprises a solid state battery cathode having a mixture of an active cathode material, an electronically conductive material, and a solid ionically conductive material. The active cathode material, electronically conductive material and ionically conductive material being sintered. The battery also has a solid state battery anode made of a mixture of an active anode material, an electronically conductive material, and a solid ionically conductive material. The active anode material, electronically conductive material and ionically conductive material being sintered. Lastly, the battery has a separator positioned between the solid state battery cathode and the solid state battery anode.

### BRIEF DESCRIPTION OF THE DRAWINGS

FIG. 1A is a perspective view of a battery embodying principles of the invention in a preferred form.

FIG. 1B is a cross-sectional view of the battery of FIG. 1A.

FIG. 2 is schematic view representing the method of manufacturing the battery of FIG. 1A.

FIG. 3 is a perspective view of a battery embodying principles of the invention in another preferred form.

FIG. 4 is a cross-sectional view of the battery of FIG. 3.

### DETAILED DESCRIPTION

With reference next to the drawings, there is shown a battery 10 in a preferred form of the invention. The battery 10 includes a polymer electrolyte composite cathode 11, an amorphous electrolyte 13, a protective battier material 14, a protected lithium metal anode 15, and an insulation material 16. The battery 10 disclosed herein consists of a composite cathode 11 composing powders of an active cathode material such as the lithium intercalation compounds lithium nickel oxide, lithium titanate, lithium cobalt oxide, lithium manganese oxide, or a mixed compound of these active components such as lithium nickel cobalt manganese oxide (LiNiₓCo_{y}Mn_{z}O₂) or other electrochemically active battery cathode material (preferably a material that undergoes no, or minimal expansion or contraction during charge and discharge cycling), a solid state lithium based electrolyte 13 of lithium lanthanum titanate (LiₓLa_{y}TiO₃, lithium lanthanum zirconate (LiₓLa_{y}ZrO₃), or organic (lithium phthalocyanine) or similar solid-state electrolyte with high ionic conductivity, and if necessary an additional additive such as carbon black to provide electronic conductivity. The constituents of the cathode 11 are thoroughly mixed and combined with a sol-gel electrolyte precursor solution of the lanthanum lithium titanate or lithium lanthanum zirconate LiₓLa_{y}ZrO₃ component and then pressed as a pellet, spin or spray coated, cast, or printed to produce a cathode that is 10 μm to 1 mm thick. The sol-gel electrolyte acts as a binder for the pellet. The ionically conductive component dispersed in the cathode provides a low impedance parallel path for transport of Li ions from the active cathode component throughout the thick cathode construction to allow for high rate capability in the resulting cell. The electrically conductive component dispersed in the cathode provides low impedance for transport of electrons throughout the thick cathode construction to allow for high rate capability. The cathode can be constructed to stand alone as in a pressed pellet, or can be fabricated onto a thin substrate. If the standalone construction is used, a current collector (copper or similar metal) can be sputtered or evaporated as a coating to act as a current collector and to provide electrical contact to the cathode. Alternatively, if the cathode is spin or spray coated or printed onto a substrate, then the substrate will be first coated with a suitable current collector to provide electrical contact to the cathode. The substrate material can be a metal foil or ceramic or polymer material. A main advantage of using all solid ceramic electrodes is the elimination of the need for external hermetically sealed packaging. As the ceramic electrode itself provides a barrier to moisture, active materials enclosed therein are protected.

A composite cathode material using electrolyte precursor solution as a binder is gelled and subsequently sintered at elevated temperature to achieve strong bonding between the constituents leading to excellent electrochemical performance for the cell with high energy density and power density. A composite cathode formed in this manner can then be spin coated, spray coated, cast, or printed with a thin layer of the same sol-gel electrolyte solution used in the composite cathode to provide a thin, continuous pinhole free coating. The resulting ceramic electrolyte coating acts as a separator between the cathode and anode. To make a Li cell, a thin film (˜2 μm) of lithium metal is evaporated onto the electrolyte separator as the anode. One approach is to fabricate two such cells and to bond them together back to back with the lithium anode sealed inside and protected from the outside ambient environment by the solid ceramic cathodes. A lithium battery fabricated in such a manner would not require additional packaging.

In an alternate design to make a Li-ion cell, a Li ion intercalation compound having a low lithium reaction potential can be used in combination with an intercalation material that has a higher reaction potential to form an all solid state battery having a ceramic based cathode and ceramic based anode. The cathode and anode are bonded together by ceramic electrolyte separator that would be initially applied using sol-gel precursor solution. The all ceramic cell thus created is stable in air and needs no packaging. For more stringent applications, such as use in high temperature environments, or if multiple cells are to be combined to increase the available capacity, the battery may be contained in a metal or other enclosure to provide additional support or protection. Batteries constructed in this manner are suitable for printing.

Based on the processes detailed herein, all solid state batteries can be fabricated with a composite cathode, solid thin film electrolyte and a lithium metal anode to form an all solid state lithium battery. In an alternate manifestation, an all ceramic solid state battery can be fabricated using a similar composite cathode, solid thin film electrolyte, and a composite anode as a lithium intercalation material to form a Li-ion battery. The composite lithium intercalation anode is formed using similar methods to the composite cathode described below.

The composite cathode can be formed from the solids/sol-gel mixture by uniaxial compression of the materials in a die, by spin coating or casting the components from a slurry on a thin substrate (of metal or ceramic or polymer) or by printing the mixture by screen printing or from a dot matrix printer. The all solid-state battery consists of a composite cathode containing active battery cathode material (e.g. LiCoO₂, LiMn₂O₄, LiNiO₂) or in a preferred form with an active battery cathode material that undergoes no expansion and contraction on charge and discharge cycling (e.g. LiNiₓCo_{y}Mn_{z}O₂ hereafter LNCM, or Li₄Ti₅O₁₂ hereafter LTO, or similar), an ionically conductive solid state electrolyte material such as LaₓLi_{y}TiO₃ (hereafter LLTO), lithium lanthanum zirconate LiₓLa_{y}ZrO₃ (hereafter LLZO) and an electronically conductive material (e.g. carbon black, Ni, Cu or similar).

The cathode can be formed as either a thick pellet or as a thin film containing the mixture of components in a matrix formed from a sol-gel solution of the ionically conductive LLTO component. The LLTO or similar precursor solution acts as a bonding agent during assembly and processing. The subsequent gelling, curing, and sintering process converts the precursor into solid ceramic material. This process results in high ionic conductive interface contact and high ionic conductive material cross sections between the constituents of the composite cathode. This resulting electrolyte dense pellet allows fast transport of Li ions and electrons throughout the cathode. The composite cathode is sintered as required to improve the bonding between the constituents and to crystallize the LLTO or similar ionic component leading to increased ionic conductivity.

In one form, the active cathode powder (LNCM or similar) is mixed with LLTO (or similar) ionically conductive powder by ball milling or similar method to thoroughly mix the components. The powder particle size is selected to obtain optimum intermixing and connected pathways through the material when it is fully formed. Particle distributions from 0.1 μm to 10 μm and compositions from 50:50 LNCM:LLTO to 100:0 LNCM:LLTO depending on the quality of intermixing of the constituents. The intermixed powders are then pressed in a die to form a pellet of given diameter depending on the required size/capacity of the resulting battery. The pellet is pressed at pressures of 1-25T/cm² depending on the density/structure of pellet required. If the pellet constituents can only be weakly bonded by pressure alone, standard additives such as stearic acid or cellulose binders commonly used in pellet pressing can be added to improve the strength and density of the pellet to improve handling prior to the sintering step that follows.

Next the pellet is sintered at elevated temperature between 700° C. and 1100° C. to form a stronger pellet structure with excellent electrical contact between the constituents. The sintering temperature and temperature/time profile is chosen to control the degree of bonding between the constituents. It is essential to obtain intimate electrical contact and bond strength between the constituent powders but it is equally important that the sintering does not cause any phase changes in the individual components. Phase changes may result in the formation of interstitial materials that no longer retain the properties required for optimal performance of the composite cathode in a working battery. The ramp speed to reach the required temperature must be controlled to allow even sintering of the pellets to prevent cupping or cracking of the pellet. Ramp speeds for increasing temperature from 30-200° C./hour and similar for the cooldown are used to obtain evenly sintered pellets with minimal phase change of the constituents.

The amount of powder mix is chosen to produce a pellet of thickness from 100 um to 1 mm depending on the rate capability required in the resulting cell and the ionic and electronic conductivity of the components chosen (higher conductivities allow for thicker cathode pellets). The active cathode material used can be chosen for its specific performance characteristics such as high voltage, high rate capability, high capacity or improved high temperature performance, and the choice of material will alter the mix of components and the thickness of the pellet.

If the active cathode material has high electronic conductivity such as LiNiO₂ and LNCM the cathodes can be fabricated thicker and there is no need for an additional additive in the cathode besides the ionically conductive component.

For active cathode materials with lower electronic conductivity such as LiMn₂O₄, carbon or another electrical conductor (e.g. Cu, Ni) can be added to increase the electronic conductivity. One method to achieve this is as follows.

Prior to the initial mixing of the active cathode material and ionically conductive material described above, graphitic carbon is also added. The particle size (0.1 μm to 20 μm) and amount of graphitic carbon (2-20 weight percent) are chosen to obtain a required degree of porosity in the pellet. After thoroughly mixing the three constituents by ball milling or other mixing method, the mixed components are then pressed into a pellet and sintered at elevated temperatures as before. Similar temperature processing and temperature/time profiles used for the dual component cathode described above still results in bonding of the active cathode material and ionically conductive component but the graphitic carbon component burns out by combining with oxygen in the ambient air to evolve CO₂ gas. The porosity/voids left by the loss of the carbon component, form a network of open pathways throughout the composite cathode. These open pathways are then available to be subsequently back-filled with a conductive material. The backfill process can be achieved using different methods depending on the desired electrically conductive component In one method, the voids can be filled with carbon black nanopowder by preparing a slurry of this material in a solvent such as isopropanol. The porous pellet created after sintering is placed in a chamber that is then evacuated to rough vacuum levels (1 torr to 10⁻³ torr) using a mechanical pump. If necessary, a hot plate at 50-100° C. inside the chamber can be used to heat up the pellet to speed up removal of gas from the pores in the pellet. After the pores in the pellet have been evacuated, the pumping line is then closed off and another valve opened to allow the carbon black slurry into the chamber. Because of the vacuum in the pores the slurry is efficiently pulled into the pellet to completely fill the voids without the formation of “air locks” that might prevent complete filling of the pores if non vacuum methods were used. In this way, once the solvent evaporates a highly conductive pathway of carbon remains throughout the pores forming highly conductive pathways in the pellet.

In an alternate approach, nickel or copper nitrate solution in water can be used to achieve the conductive pathway. The process is essentially the same as that described above for carbon black but the slurry of carbon powder is replaced by the copper or nickel nitrate aqueous solution. The voids are formed in the pellet by adding graphitic carbon and burning it out in the same way as described above. The nickel nitrate or copper nitrate solution is again pulled into the voids using vacuum as before. When the solution dries, it leaves nickel nitrate or copper nitrate in the porous pathways throughout the material. The pellet is then placed in a furnace and heated to 200-500° C. for 0.5-3 hours in flowing hydrogen. This heat treatment reduces the nickel/copper nitrate to form pure Ni or Cu metal chemically bound within the pellet. This process can be repeated as necessary to completely fill the pores in the material with the conductive component to achieve the required level of electronic conductivity.

If the chosen cathode active material shows insufficient bonding with the ionically conductive component powder by sintering, or if the ionic conductivity must be enhanced in the cathode pellet to enable use of a thicker pellet, additional conductivity and bonding can be achieved using a sol-gel solution of the ionic conductor in addition to the powder of that material. For example the LLTO material can be formed by mixing standard precursors of the constituents (e.g Li butoxide Ti propoxide and Lanthanum methoxyethoxide) in methoxyethanol solvent to form the sol. The liquid sol is then added to the powders of active cathode material LNCM, and ionically conductive powder of LLTO and is mixed with the powders to achieve a uniform homogenous mixture. The mixture formed is then pressed into a pellet in the same way as described above for just the powder constituents, and the pellet is allowed to sit in order for the sol to hydrolyze into the gel and release the solvent. Next, during the subsequent sintering process at 700° C.-1100° C. the gel forms into the ionically conductive ceramic material to improve the bonding between the powder constituents. The surface tension of the sol causes it to collect at the contact points between the constituent powders and thus improve the necking or bonding and electrical/ionic contact within the material.

A battery requires an electronic current collector as a positive contact to the composite cathode. For standalone pressed cathodes this current collector can be directly deposited onto one side of the pellet. In one form a Ni metal or similar current collector can be deposited by DC (Direct current) sputtering in argon gas to form a layer from 200-1000 nm thick.

If thinner or larger area cathodes are needed that cannot be achieved by pressing pellets an alternate approach is to fabricate the cathode by using casting methods to form a green tape of the constituents by the following method.

The cathode components are again thoroughly mixed by ball milling for 2-24 hours at rotation speeds from 200-500 rpm to obtain a homogenous mixture. The mixed powder is then added to a slurry containing a binder such as PVB dissolved in a solvent (e.g. ethanol) and a plasticizer (e.g. polyethylene glycol or similar) to provide structure to the layer. If necessary a dispersant can be added to more evenly distribute the components. The slurry is then cast evenly onto a lift off surface such as Mylar using a doctor blade to set the required layer thickness. Large area layers from 20 μm to 500 μm can be formed using this method. The cast layer is dried and then peeled away from the Mylar before being cut to size. The cut sheets are then sintered to burn out the additives and obtain good contact between the active cathode and ionically conductive powders in the layer. The sintering temperatures and time/temperature profiles are similar to those already described above in detail for the pressed pellet composite cathode. A current collector such as Ni metal or similar can be directly deposited onto one side of the cathode sheet by DC sputtering or similar deposition method in a similar method to that described above for the pressed pellet.

In an alternate form to make thin cathode layers less than 20 μm thick, thin films of the composite cathode can be cast onto a thin foil substrate. These layers are thin enough that the pure cathode active material can usually be cast alone with no additional additives needed. However, additional materials can still be added for electronic and ionic conductivity enhancement if necessary. The additives are simply inserted and mixed into the slurry in the same way as described above for the pellet pressing method. The foil can be any material that can withstand the sintering temperature chosen for the cathode material. Ni foil from 10-50 μm can been used to successfully form LNCM cathodes sintered to 900° C. An oxide 200 nm-3 μm thick is formed on the foil by pre-heat treating in air at 400° C. to 700° C. for 1-5 hours. The oxide is required to prevent Ni metal diffusion into the cast active cathode material during high temperature sintering. Stainless steel foil can be used if higher temperature sintering is necessary up to 1,100° C., but in this case an alternate oxide (e.g. Al₂O₃, SiO₂ or similar) must be deposited by sputtering or other deposition method.

The current collector for this method must be deposited onto the foil prior to the casting and sintering process which means the current collector must maintain its electrical conductivity through the high temperature sintering step. To achieve this, following formation of the Ni oxide on the foil surface an adhesion layer such as Ti, Ni, or Co or similar is deposited by DC sputtering at a layer thickness of 10-100 nm. Next, a layer of Au from 150-300 nm is deposited on top of the adhesion layer to form the highly conductive current collector.

It should be noted again here that identical methods described above for forming a composite cathode structure can also be used to form a composite anode structure. The only difference in the composite anode compared to the composite cathode is the active intercalation material used. For example, an active composite anode would use lithium titanate (lithium titanium oxide) (hereafter LTO) as the active material (1.5V versus Li). Then this composite anode pellet can be combined with an LNCM composite cathode pellet (˜4.0V versus Li) to form an all ceramic battery structure with a voltage of ˜2.5V.

Once a composite cathode has been fabricated using one of the methods described above an electrolyte layer must be applied to provide a conductive path for Li ions but that also prevents electronic conductivity that can short out the battery. To complete a lithium battery that uses a lithium metal anode the Li metal can be directly evaporated onto this electrolyte. This means that the electrolyte can be formed by a number of methods including sputtering or pulsed laser deposition of a thin film of the solid electrolytes that include LiPON, LiNbON, LLTO, or LLZO.

However, in the alternate form of the all ceramic solid state Li-ion battery the battery can be constructed using the composite cathode described above and a composite anode in place of the Li metal anode. The composite anode is fabricated using identical methods to the composite cathode but using a lower voltage material such as LTO. Although the Li metal anode cell can be completed by depositing the Li metal, the composite anode must be attached to the cathode by an alternate method, and the proposed solution described below is to use the sol-gel method to form an electrolyte from a solution to bind the anode and cathode together.

The sol-gel method is a lower cost fabrication system that does not require high cost large scale vacuum deposition equipment. LLTO or LLZO layers have been formed from a sol-gel solution. The liquid sol is made by dissolving precursors of the constituent materials in a solvent as described above where the sol-gel material is used as an ionically conductive additive used in the composite cathode. Here, in order to form a thin film electrolyte coating on top of the composite cathode, the liquid sol is cast or spin coated or spray coated to form a layer which is then allowed to hydrolyze and gel during removal of the solvent. The layer is then fully formed into the amorphous electrolyte with high ionic conductivity by heating the structure to between 300 and 700° C.

As detailed above, this lower cost electrolyte can be used to replace sputtered electrolytes. Once the electrolyte layer is formed on the cathode pellet a Li anode can be directly evaporated onto the electrolyte to complete a lithium battery. The sol-gel method however, is essential for fabricating the alternate manifestation of an all ceramic solid state Li-ion battery. The composite cathode must be attached directly to a composite anode using an electrolyte separator. The sol electrolyte is cast or spin coated or spray coated onto the composite cathode and also onto the composite anode. The cathode and anode are then joined before allowing the sol to gel. Once the gelling is complete the full composite cathode/electrolyte/composite anode structure can be heated to between 300° C. and 700° C. to fully form the all ceramic solid state battery.

Using the fabrication methods described above all solid state batteries can be constructed using the processes described below.

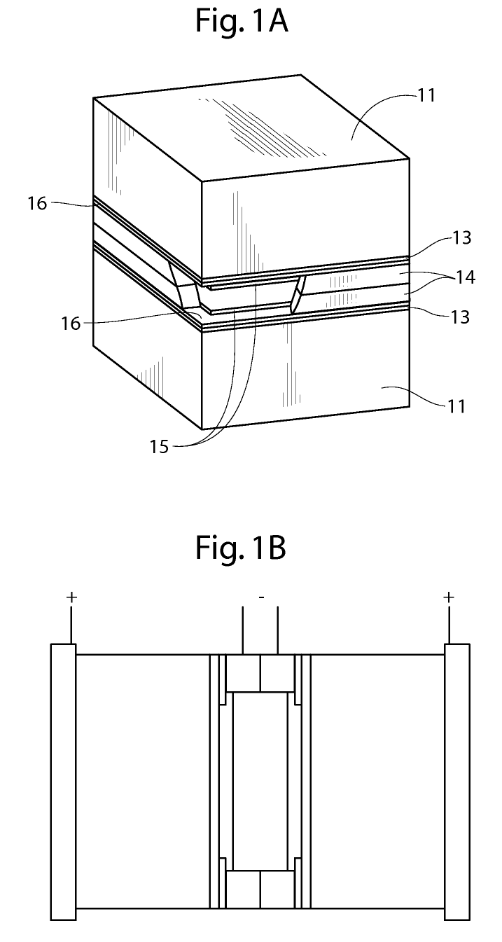

The components of the lithium battery form are shown in FIG. 1A. The composite cathode has a sputtered metal current collector on one side and the thin electrolyte and Li anode evaporated on the other side. Two such cells are then bonded back to back (anode-to-anode) forming an anode cavity within which the lithium anode is sealed and isolated from the ambient environment. During the charge cycle the active cathode material (e.g. LNCM) component in the cathode provides Li in ionic form which is transferred across the solid electrolyte to the Li metal anode to store energy. During discharge the Li is again ionized to release an electron which provides power in the external circuit while the Li ion returns to the cathode where it recombines with the electron.

FIG. 1A shows components of the novel all solid-state lithium battery including the composite cathode/electrolyte matrix, thin electrolyte separator, Li anode, anode and cathode current collector. FIG. 1B shows a cross sectional view of the cell. By maximizing the cathode thickness relative to the other layers of the cell the energy density is optimized. The cathode matrix with high ionic and electronic conductivity allows access to the full capacity of the cathode material at high rates, leading to high power density.

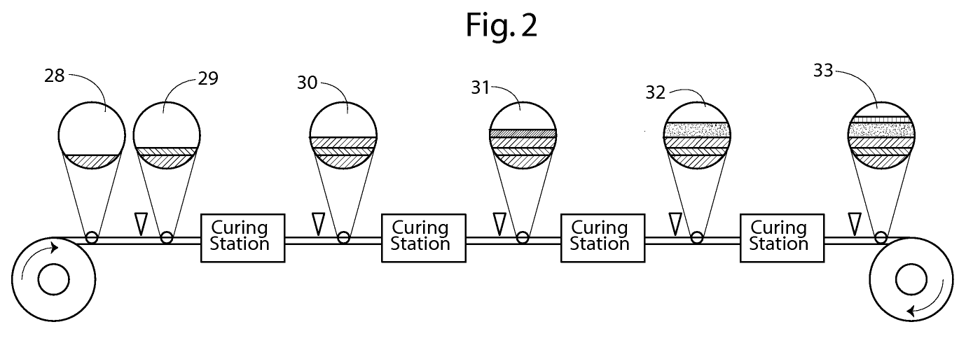

In a second form, the cathode can be printed or formed on a substrate 28 as shown schematically in FIG. 2. In this case, the current collector 29 can be applied to the substrate 28 before the cathode is applied. The composite cathode 30 is thin coated on top of the cathode current collector. Next an ionic conductive electrolyte separator 31 is spin coated, spray coated or printed onto the cathode to completely cover the cathode's surface. The electrolyte layer can be formed from the same sol-gel solution used in the composite cathode and allowed to gel to form the separator. Anode slurry 32 is applied on top of the cell next. This slurry is very similar to that used for the cathode except a lower voltage lithium intercalation compound is utilized than that used in the cathode. The cathode intercalation material may be a high voltage material such as LiCoO2, LiMn2O4 or LiNiO2 or LNCM or mixtures thereof and the anode may use a lower voltage intercalation material such as graphite, LTO, LiSnN or similar materials that are well known to have the desired properties. After the curing of the anode is complete, the anode current collector 33 is applied on top of the anode as the final step in the process.

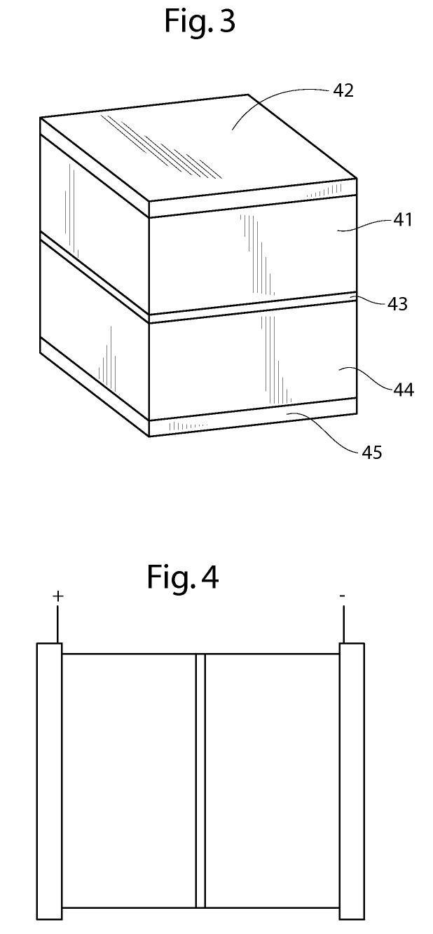

The cell depicted in FIG. 3 represents a battery structure in another preferred form of an all solid state ceramic Li-ion battery 40. The battery 49 includes a componside cathode 41, a cathode current collector 42, a thin film electrolyte 43, a composite anode 44, and an anode current collector 45. In this approach, cathode 41 and anode pellets are used so that the battery has an IC chip or pellet like geometry. The cell does not require use of a substrate during the assembly process. Solid ceramic material forms an ionic conductive matrix that bonds the cell together in a manner similar to the way polymer gel electrolytes bond polymer cells together. However, in this case, greater versatility is offered by the present invention in that the ceramic electrolyte encapsulates the active materials of the cell and protects them from the ambient environment thereby eliminating the need for external packaging.

The invention enables high energy density and power density in a low cost Li or Li-ion cell through the realization of an all solid-state composite cathode and anodes using sol gel precursors for ceramic electrolyte material. Sol gel methods are also used to form ionic conductive ceramic separators. The sol-gel method is a synthesis process, which has the advantages of easy and low cost preparation, good control over stoichiometry, and a high deposition rate. The active cathode component is dispersed in a matrix of solid electrolyte allowing for fabrication of thick cathodes with full access to the cathode material without the need for liquid or polymer components. This also leads to higher stability, shelf and operational lifetime and safety compared to existing Li-ion technologies.

It thus is seen that a battery is now provided which overcomes problems associated with those of the prior art. It should of course be understood that many modifications may be made to the specific preferred embodiment described herein without departure from the spirit and scope of the invention as set forth in the following claims.

1. A solid state battery cathode comprising a mixture of an active cathode material, an electronically conductive material, and a solid ionically conductive material, said mixture of said active cathode material, said electronically conductive material and said ionically conductive material being sintered.

2. The solid state battery cathode of claim 1 wherein said solid ionically conductive material is a lithium based electrolyte.

3. The solid state battery cathode of claim 2 wherein said lithium based electrolyte is selected from the group consisting of lithium lanthanum titanate, lithium lanthanum zirconate and lithium phthalocyanine.

4. The solid state battery cathode of claim 1 wherein said active cathode material is a lithium intercalation material.

5. The solid state battery cathode of claim 4 wherein said lithium intercalation material is selected from the group consisting of lithium nickel cobalt manganese oxide, lithium nickel oxide, lithium cobalt oxide, lithium titanium oxide and lithium manganese oxide.

6. A solid state battery anode comprising a mixture of an active anode material, an electronically conductive material, and a solid ionically conductive material, said active anode material, said electronically conductive material and said ionically conductive material being sintered.

7. The solid state battery anode of claim 6 wherein said solid ionically conductive material is a lithium based electrolyte.

8. The solid state battery anode of claim 7 wherein said lithium based electrolyte is selected from the group consisting of lithium lanthanum titanate, lithium lanthanum zirconate and lithium phthalocyanine.

9. The solid state battery anode of claim 6 wherein said active anode material is a lithium intercalation material.

10. The solid state battery anode of claim 9 wherein said lithium intercalation material is lithium titanate.

11. A solid state all ceramic battery comprising,
solid state battery cathode comprising a mixture of an active cathode material, an electronically conductive material, and a solid ionically conductive material, said active cathode material, said electronically conductive material and said ionically conductive material being sintered,
solid state battery anode comprising a mixture of an active anode material, an electronically conductive material, and a solid ionically conductive material, said active anode material, said electronically conductive material and said ionically conductive material being sintered, and
a solid state separator positioned between said solid state battery cathode and said solid state battery anode.

12. The solid state all ceramic battery of claim 11 wherein said cathode solid ionically conductive material is a lithium based electrolyte.

13. The solid state all ceramic battery of claim 12 wherein said cathode lithium based electrolyte is selected from the group consisting of lithium lanthanum titanate, lithium lanthanum zirconate and lithium phthalocyanine.

14. The solid state all ceramic battery of claim 11 wherein said cathode active cathode material is a lithium intercalation material.

15. The solid state all ceramic battery of claim 14 wherein said cathode active cathode material lithium intercalation material is selected from the group consisting of lithium nickel cobalt manganese oxide, lithium nickel oxide, lithium cobalt oxide, and lithium manganese oxide.

16. The solid state all ceramic battery of claim 11 wherein said anode solid ionically conductive material is a lithium based electrolyte.

17. The solid state all ceramic battery of claim 12 wherein said anode lithium based electrolyte is selected from the group consisting of lithium lanthanum titanate, lithium lanthanum zirconate and lithium phthalocyanine.

18. The solid state all ceramic battery of claim 11 wherein said anode active anode material is a lithium intercalation material.

19. The solid state all ceramic battery of claim 18 wherein said anode active anode material lithium intercalation material is lithium titanate.

20. The solid state all ceramic battery of claim 13 wherein said anode solid ionically conductive material is a lithium based electrolyte.

21. The solid state all ceramic battery of claim 20 wherein said lithium based electrolyte is selected from the group consisting of lithium lanthanum titanate, lithium lanthanum zirconate and lithium phthalocyanine.

22. A method of forming a solid state battery cathode comprising the steps of:
(a) providing a quantity of an active cathode material;
(b) providing a quantity of an electronically conductive material;
(c) providing a quantity of a solid ionically conductive material;
(d) mixing the active cathode material, the electronically conductive material and the ionically conductive material, and
(e) sintering the mixture of the active cathode material, the electronically conductive material and the ionically conductive material being sintered.

23. The method of claim 22 wherein step (c) said solid ionically conductive material is a lithium based electrolyte.

24. The method of claim 23 wherein step (c) the lithium based electrolyte is selected from the group consisting of lithium lanthanum titanate, lithium lanthanum zirconate and lithium phthalocyanine.

25. A method of forming a solid state battery anode comprising the steps of:
(a) providing a quantity of an active anode material;
(b) providing a quantity of an electronically conductive material;
(c) providing a quantity of a solid ionically conductive material;
(d) mixing the active anode material, the electronically conductive material and the ionically conductive material, and
(e) sintering the mixture of the active anode material, the electronically conductive material and the ionically conductive material.

26. The method of claim 25 wherein step (c) the solid ionically conductive material is a lithium based electrolyte.

27. The method of claim 26 wherein step (c) the lithium based electrolyte is selected from the group consisting of lithium lanthanum titanate, lithium lanthanum zirconate and lithium phthalocyanine.
